(19) United States
(12) Patent Application Publication
(10) Pub. No.: US 2009/0108538 A1
(43) Pub. Date: Apr. 30, 2009

(54) Two-Component Seal With Integral Locking Feature To Prevent Relative Rotation

(75) Inventors: Michael D. Downes, Woodinville, WA (US); Jason Brooks Fairbanks, Salt Lake City, UT (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/877,702

(22) Filed: Oct. 24, 2007

(51) Int. Cl. F16J 15/32

(52) U.S. Cl. 277/553

(57) ABSTRACT

A rotary seal is provided. The rotary seal includes an annular seal element having a sealing surface. The seal element further includes a surface opposite of the sealing surface including a first coupling portion. The rotary seal also includes an annular energizer including a second coupling portion complementary to the first coupling portion. The first and second coupling portions engage so as to inhibit relative rotation between the seal element and the energizer.

### FIELD

The present disclosure relates to rotary seals and, more particularly, to two-component rotary seals including a seal element and an energizer.

### BACKGROUND

The statements in this section merely provide background information related to the present disclosure and may not constitute prior art.

Rotary seals are used in a variety of applications. Conventional rotary seals can include a plurality of components such as a seal element and an energizer. However, relative rotation between such rotary seal components can itself cause wear and can result in seal leakage. Therefore, such relative rotation can lead to seal failure and, therefore, undesirable performance and/or damage of a device or apparatus utilizing the seal.

Accordingly, it is desirable to provide a rotary seal which inhibits relative rotation between components thereof.

### SUMMARY

The present disclosure provides a rotary seal. The rotary seal includes an annular seal element. The seal element includes a first coupling portion opposite of a sealing surface. The rotary seal also includes an annular energizer including a second coupling portion engaging the first coupling portion of the seal element. The first and second coupling portions engage so as to inhibit relative rotation between the seal element and the energizer.

The present disclosure further provides a method of inhibiting wear of a rotary seal. The method includes integrally forming a first coupling portion on an annular seal element. The seal element has a sealing surface. The method further includes integrally forming a second coupling portion on an annular energizer and engaging the first coupling portion and the second coupling portion so as to inhibit relative rotation between the seal element and the energizer.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an exemplary rotary seal according to the principles of the present disclosure;

FIG. 2 is a partially cut-away perspective view of a portion of the exemplary rotary seal of FIG. 1;

FIG. 3. is an end view of an exemplary energizer according to the principles of the present disclosure;

FIG. 4 is an end view of an exemplary seal element according to the principles of the present disclosure;

FIG. 5 is an end view of an exemplary rotary seal according to the principles of the present disclosure including the energizer of FIG. 3 and the seal element of FIG. 4;

FIG. 6 is a cross sectional view of an exemplary rotary assembly according to the principles of the present disclosure;

FIG. 7 is a cross sectional view of exemplary alternative rotary seal according to the principles of the present disclosure;

FIG. 8 is a cross sectional view of another exemplary alternative rotary seal according to the principles of the present disclosure;

FIG. 9 is a partially cut-away perspective view of an exemplary alternative rotary seal according to the principles of the present disclosure; and

FIG. 10 is a partially cut-away perspective view of an exemplary alternative rotary seal according to the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. For example, the reference numerals 15, 15′, and 15″ could indicate corresponding parts and features.

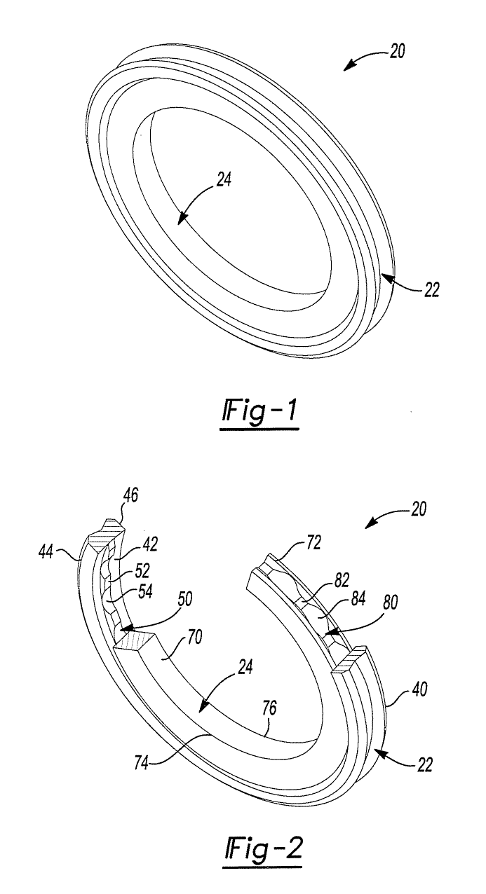

With reference to FIGS. 1-2 and 5, an exemplary rotary seal 20 according to the principles of the present disclosure is an assembly including a seal element 22 and an energizer 24 for use in a piston or bore application. In particular, seal element 22 has a generally annular shape and is configured to engage a cylinder member as described in further detail herein, and energizer 24 has a generally annular shape and is disposed radially inward of seal element 22. Energizer 24 can provide a radially outward force on seal element 22 to enhance the sealed engagement of seal element 22 and the cylinder member. Additionally, as described in further detail herein, energizer 24 can also be configured to sealingly engage another component of a rotary assembly.

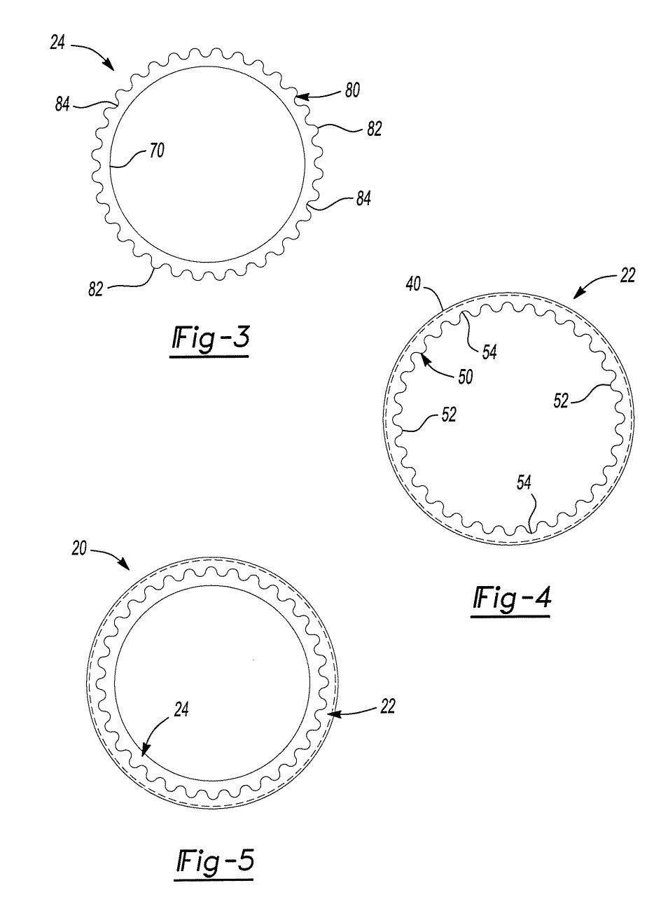

With reference to FIGS. 2-3, seal element 22 includes a radially outward sealing surface 40 and a radially inward surface 42 opposite outward sealing surface 40. Side surfaces 44, 46 extend between outward sealing surface 40 and inward surface 42. Furthermore, a coupling portion 50 is integrally formed on inward surface 42. Coupling portion 50 includes alternating protrusions 52 and grooves 54. Protrusions 52 extend radially inwardly and axially from inward surface 42, and grooves 54 extend between adjacent protrusions 52 and along an axial direction. Coupling portion 50 can extend continuously around inward surface 42 with protrusions 52 and grooves 54 alternating continuously around inward surface 42.

Seal element 22 can be made of a variety of materials. By way of non-limiting example, seal element 22 can include urethane, nitrile, PTFE, nylon, PPS, PEEK, acetile, polyethylene, polyamide, EPBM, FKM, CR, polyester, any thermoplastic or thermoset elastomer or plastic and hydrogenated nitrile butadiene rubber.

With reference to FIGS. 2 and 4, energizer 24 includes a radially inward surface 70 and a radially outward surface 72 opposite inward surface 70. Side surfaces 74, 76 extend between inward surface 70 and outward surface 72. Furthermore, a coupling portion 80 is integrally formed on outward surface 72. Coupling portion 80 includes alternating protrusions 82 and grooves 84. Protrusions 82 extend radially outwardly from outward surface 72, and grooves 84 extend between adjacent protrusions 82 and along an axial direction. Coupling portion 80 can extend continuously around outward surface 72 with protrusions 82 and grooves 84 alternating continuously around outward surface 72. Additionally, as described in further detail herein, coupling portion 50 of seal element 22 and coupling portion 80 of energizer 24 are complementary to each other.

Energizer 24 can be made of a variety of materials. By way of non-limiting example, energizer 24 can be made of an elastomeric material such as hydrogenated nitrile butadiene rubber, urethane, nitrile, PTFE, nylon, PPS, PEEK, acetile, polyethylene, polyamide, EPBM, FKM, CR, polyester, any thermoplastic or thermoset elastomer or plastic.

Referring again to FIGS. 1-2 and 5, energizer 24 is disposed radially inwardly of seal element 22 to assemble rotary seal 20. In particular, outward surface 72 of energizer 24 engages inward surface 42 of seal element 22 so that coupling portions 50, 80 engage and interact. With particular reference to FIG. 5, as coupling portions 50, 80 are complementary to each other, protrusions 52 of seal element 22 extend along and contact grooves 84 of energizer 24, while protrusions 82 extend along and contact grooves 54.

It should be understood that, according to the principles of the present disclosure, the shapes and/or patterns of coupling portions 50, 80 can vary. For example, coupling portions 50, 80 are configured with patterns so as to create enough mechanical engagement/friction to inhibit relative rotation between seal element 22 and energizer 24. Therefore, rotation between elements is eliminated and wear and failure of rotary seal 20 can be prevented. Furthermore, coupling portions 50, 80 can also have patterns which are subtle enough so as to provide for intermeshing of coupling portions 50, 80 during installation. As such, coupling portions 50, 80 can provide for relatively simple assembly and installation of rotary seal 20. Additionally, it should be understood that coupling portions 50, 80 can be formed in a variety of ways. Therefore, it should be understood that the descriptions and illustrations of coupling portions 50, 80 in the present application are exemplary and/or explanatory in nature.

Additionally, coupling portions 50, 80 can be located at axially central positions on seal element 22 and energizer 24, respectively. As a result, any variation in load pattern in rotary seal 20 due to the interface between coupling portions 50, 80 can be located away from critical sealing areas.

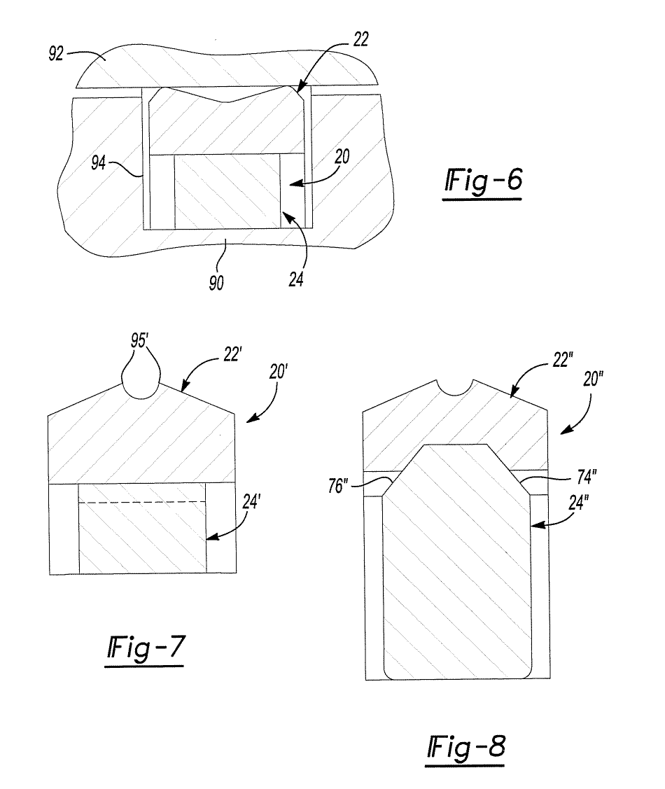

With reference to FIG. 6, a rotary assembly according to the principles of the present disclosure includes rotary seal 20 extending between a rotary member 90 such as a piston and a housing 92 such as a cylinder. Rotary member 90 and rotary seal 20 are rotatable relative to housing 92. Rotary seal 20 inhibits fluid communication past the seal. In particular, rotary seal 20 is disposed within a seal bore (annular groove) 94 of rotary member 90. Furthermore, seal element 22 sealingly engages housing 92, and energizer 24 sealingly engages rotary member 90 opposite seal element 22. Seal member 22 can include two laterally spaced ribs 95 which sealingly engage the housing 92.

According to the principles of the present disclosure, rotary seal 20 can be used in a variety of applications. By way of non-limiting example, rotary seal 20 can be used in rotary actuators and rotary manifolds and any other high pressure rotary device.

With reference to FIGS. 7-8, exemplary alternative configurations of rotary seals according to the principles of the present disclosure are illustrated. Unless otherwise noted, it should be understood that the descriptions herein of corresponding components apply to these exemplary alternatives. Referring to FIG. 7, rotary seal 20′ includes seal element 22′ and energizer 24′. In particular, seal element 22′ has a different shape than the corresponding component described herein. In particular, ribs 95′ are more closely spaced and combine to form a peak region in the middle. Additionally, referring to FIG. 8, rotary seal 20″ includes seal element 22″ and energizer 24″. In particular, both seal element 22″ and energizer 24″ have different interface configurations than the corresponding components described herein. In particular, the side surfaces 74″, 76″ of the energizer 24″ are angled inward.

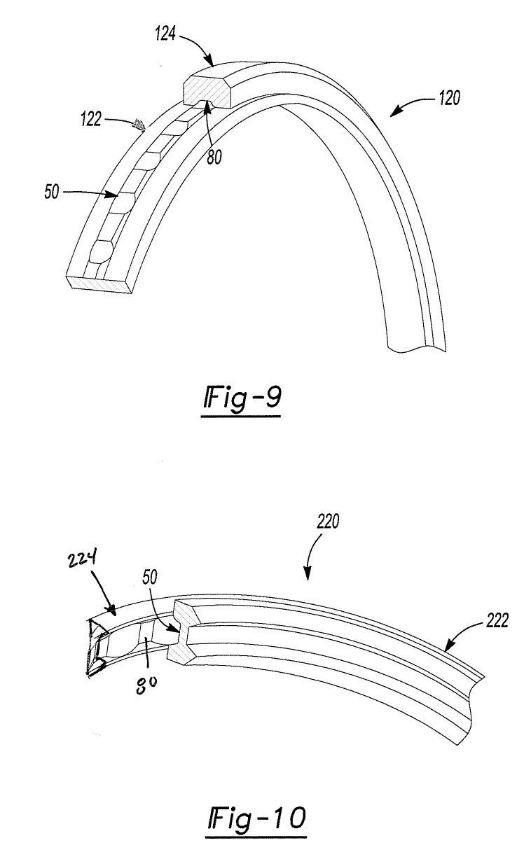

With reference to FIG. 9, the rotary seal 120 can be reversed with the seal member 122 disposed radially inward of the energizer 124. In this configuration, the seal 120 can be used as rod/shaft seal configuration for sealing radially inwardly against a rod or shaft. The coupling portions 50, 80 are provided for preventing relative rotation therebetween.

With reference to FIG. 10, the rotary seal 220 can be arranged as a face seal with the seal member 222 disposed axially adjacent to the energizer 224, so that the energizer 224 provides an axial bias against the seal member 222. The coupling portions 50, 80 are provided for preventing relative rotation therebetween.

The present disclosure can vary in many ways. For example, a rotary seal according to the principles of the present disclosure the seal can be used in a variety of applications. Furthermore, the components of a seal according to the principles of the present disclosure have a variety of configurations and can be made of a variety of materials. For example, a sealing element of a rotary seal according to the principles of the present disclosure can have a variety of shapes, and a variety of energizers can be used in a rotary seal according to the principles of the present disclosure. Additionally, features such as coupling portions of a rotary seal according to the principles of the present disclosure can vary. As such, it should be understood that the present disclosure is exemplary in nature.

What is claimed is:

1. A rotary seal comprising:
an annular seal element including a sealing surface, said seal element further including a surface opposite of said sealing surface including a first coupling portion; and
an annular energizer including a surface engaging said seal element including a second coupling portion complementary to said first coupling portion, said first and second coupling portions engaging so as to inhibit relative rotation between said seal element and said energizer.

2. The rotary seal of claim 1, wherein said first coupling portion includes a plurality of protrusions extending from said surface opposite of said sealing surface of said seal element, said first coupling portion further including a plurality of grooves disposed between said protrusions.

3. The rotary seal of claim 2, wherein said protrusions and grooves are disposed so as to continuously alternate around said surface opposite of said sealing surface of said sealing element.

4. The rotary seal of claim 2, wherein said second coupling portion includes a plurality of protrusions extending from said surface of said energizer, said second coupling portion further including a plurality of grooves disposed between said protrusions.

5. The rotary seal of claim 4, wherein said protrusions and grooves are disposed so as to continuously alternate around said surface of said energizer.

6. The rotary seal of claim 1, wherein said first coupling portion is centrally positioned on said surface of said seal element.

7. The rotary seal of claim 6, wherein said second coupling portion is centrally positioned on said surface of said energizer.

8. The rotary seal of claim 1, wherein said first coupling portion is integrally formed on said surface of said seal element.

9. The rotary seal of claim 1, wherein said second coupling portion is integrally formed on said surface of said energizer.

10. The rotary seal of claim 1, wherein said seal element includes a urethane material.

11. The rotary seal of claim 1, wherein said energizer includes an elastomeric material.

12. The rotary seal of claim 1, wherein said energizer is disposed radially inward of said seal element.

13. The rotary seal of claim 1, wherein said seal element is disposed radially inward of said energizer.

14. The rotary seal of claim 1, wherein said energizer is disposed axially adjacent to said seal element.

15. A rotary assembly comprising:
a housing;
a rotary member rotatable relative to said housing; and
a rotary seal disposed within a seal bore disposed in one of said housing and said rotary member, said rotary seal extending between said housing and said rotary member and inhibiting fluid communication past said rotary seal, said rotary seal including:
an annular seal element including a sealing surface, said seal element sealingly engaging one of said rotary member and said housing with said sealing surface, said seal element further including a surface opposite of said sealing surface including a first coupling portion, and
an annular energizer including a second coupling portion complementary to said first coupling portion, said first and second coupling portions engaging so as to inhibit relative rotation between said seal element and said energizer, said energizer sealingly engaging said other of said housing and said rotary member opposite said seal element.

16. The rotary assembly of claim 15, wherein said first coupling portion includes a plurality of protrusions extending from said surface of said seal element, said first coupling portion further including a plurality of grooves disposed between said protrusions.

17. The rotary assembly of claim 16, wherein said protrusions and grooves are disposed so as to continuously alternate around said surface of said sealing element.

18. The rotary assembly of claim 16, wherein said second coupling portion includes a plurality of protrusions extending from said surface of said energizer, said second coupling portion further including a plurality of grooves disposed between said protrusions.

19. The rotary assembly of claim 18, wherein said protrusions and grooves are disposed so as to continuously alternate around said surface of said energizer.

20. The rotary assembly of claim 15, wherein said first coupling portion is centrally positioned on said surface of said seal element.

21. The rotary assembly of claim 20, wherein said second coupling portion is centrally positioned on said surface of said energizer.
